(19) United States
(12) Patent Application Publication
(10) Pub. No.: US 2013/0064213 A1
(43) Pub. Date: Mar. 14, 2013

(54) APPARATUS AND METHOD FOR PERFORMING OR SUPPORTING COOPERATIVE COMMUNICATION BETWEEN TERMINALS IN A WIRELESS COMMUNICATION SYSTEM

(71) Applicants: Kyujin Park, Anyang-si (KR); Hangyu Cho, Anyang-si (KR); Dongguk Lim, Anyang-si (KR)

(72) Inventors: Kyujin Park, Anyang-si (KR); Hangyu Cho, Anyang-si (KR); Dongguk Lim, Anyang-si (KR)

(21) Appl. No.: 13/700,019

(22) PCT Filed: May 27, 2011
(86) PCT No.: PCT/KR2011/003908

§ 371 Date: Nov. 26, 2012

(30) Foreign Application Priority Data
May 27, 2010 (US) 61349199
May 27, 2011 (US) 61349181

(51) Int. Cl. H04W 72/04

(52) U.S. Cl. 370/329

(57) ABSTRACT

According to one embodiment of the present invention, the receiver of a base station receives, from a first terminal, a first message containing information on a first terminal identifier, information which enables a direct link connection between the first terminal and one or more candidate terminals capable of cooperative communication in a cell to which the first terminal belongs, and/or information on the mode in which the first terminal performs cooperative communication. The transmitter of the base station transmits, to said one or more candidate terminals, a message for requesting a direct link connection with the first terminal, wherein the message contains the information on the first terminal identifier and/or information on the mode in which the first terminal performs cooperative communication. The network to which the first terminal and the candidate terminals are linked is different from the network to which the first terminal and the base station are linked.

### TECHNICAL FIELD

The present invention relates to a wireless communication system, and more particularly, to an apparatus and method for performing or supporting cooperative communication between terminals.

### BACKGROUND ART

As its appellation implies, Machine to Machine (M2M) communication refers to communication between electronic devices. While M2M communication means wired or wireless communication between electronic devices or communication between a human-controlled device and a machine in its broad sense, M2M communication has recently meant especially wireless communication between electronic devices, that is, wireless communication between devices.

In the early 1990s when the concept of M2M communication was introduced, M2M communication was regarded simply as remote control or telematics and its derived market was very limited. However, M2M communication has rapidly grown over the past few years and has been developed to boost a market attracting worldwide attention as well as attention from Korea. Especially, M2M communication has a great influence on the fields of fleet management, remote monitoring of machines and facilities, measurement of the operation time of construction equipment, and smart metering, i.e. automatic metering of heat or electricity consumption in Point Of Sales (POS)-related and security-related application markets. As M2M communication will serve many more usages in conjunction with legacy mobile communication and wireless high-speed Internet or low-output communication solutions such as Wireless Fidelity (Wi-Fi) and Zigbee, it will be extended to Business to Consumer (B2C) markets beyond Business to Business (B2B) markets.

In the era of M2M communication, data transmission and reception is possible for all machines equipped with Subscriber Identity Module (SIM) cards and thus the machines can be managed and controlled remotely. For example, M2M communication finds it use in a very broad range including a number of devices and equipment such as cars, trucks, trains, containers, automatic vending machines, gas tanks, etc.

Conventionally, terminals are generally managed on an individual basis and thus a one-to-one communication environment is established between a Base Station (BS) and terminals. Considering a large number of M2M terminals in this environment, network overload is expected due to signaling between the BS and individual M2M terminals. As described above, if M2M communication gets rapidly popular and widespread, overhead caused by communication between M2M terminals or between a BS and M2M terminals may lead to a problem.

However, discussion is directed merely toward support of cooperative communication between terminals without any specified method for supporting or performing cooperative communication between terminals.

### DISCLOSURE

### Technical Problem

An object of the present invention devised to solve the conventional problem is to provide a method for performing cooperative communication between terminals in a wireless communication system.

Another object of the present invention is to provide a method for supporting cooperative communication between terminals in a wireless communication system.

Another object of the present invention is to provide a terminal for performing cooperative communication between terminals in a wireless communication system.

A further object of the present invention is to provide a base station for supporting cooperative communication between terminals in a wireless communication system.

It will be appreciated by persons skilled in the art that the objects that could be achieved with the present invention are not limited to what has been particularly described hereinabove and the above and other objects that the present invention could achieve will be more clearly understood from the following detailed description.

### Technical Solution

In an aspect of the present invention, a method for performing cooperative communication between mobile stations (MSs) in a wireless communication system includes transmitting, by a first MS, a first message requesting cooperative communication to a Base Station (BS), the first message including at least one of identification information of at least one second MS linked to the first MS and information about a cooperative communication mode for cooperative communication with the at least one second MS, and receiving, by the first MS, a second message from the BS, the second message including identification information of at least one third MS for performing cooperative communication from among the at least one second MS. A network linked between the first and second MSs is heterogeneous from a network linked between the first MS and the BS.

In another aspect of the present invention, a method for performing cooperative communication between mobile stations (MSs) in a wireless communication system includes transmitting, by a first MS, a first message requesting cooperative communication to a BS, the first message including at least one of identification information of the first MS, information about a cooperative communication mode for cooperative communication involving the first MS, and information enabling a direct link connection between the first MS and one or more candidate cooperative MSs capable of cooperative communication in a cell to which the first MS belongs, and receiving, by the first MS, a second message from the BS, the second message including identification information of at least one second MS that will perform cooperative communication from among the candidate cooperative MSs. A network linked between the first MS and the candidate cooperative MSs is heterogeneous from a network linked between the first MS and the BS.

In another aspect of the present invention, a method for supporting cooperative communication between mobile stations (MSs) in a wireless communication system includes receiving a first message requesting cooperative communication from a first MS, the first message including at least one of identification information of at least one second MS linked to the first MS and information about a cooperative communication mode for cooperative communication between the first MS and the at least one second MS, and grouping the first MS and a cooperative MS that will perform cooperative communication with the first MS based on the at least one of the identification information of the at least one second MS linked to the first MS and the information about the cooperative communication mode. A network linked between the first and second MSs is heterogeneous from a network linked between the first MS and a BS.

In another aspect of the present invention, a method for supporting cooperative communication between MSs in a wireless communication system includes receiving a first message requesting cooperative communication from a first MS, the first message including at least one of identification information of at least one second MS linked to the first MS and information about a cooperative communication mode for cooperative communication between the first MS and the at least one second MS, and

grouping the first MS and a cooperative MS that will perform cooperative communication with the first MS based on the at least one of the identification information of the at least one second MS linked to the first MS and the information about the cooperative communication mode. A network linked between the first and second MSs is heterogeneous from a network linked between the first MS and a BS.

In another aspect of the present invention, a method for supporting cooperative communication between mobile stations (MSs) in a wireless communication system include receiving a first message requesting cooperative communication from a first MS, the first message including at least one of identification information of the first MS, information enabling a direct link connection between the first MS and one or more candidate cooperative MSs capable of performing cooperative communication in a cell to which the first MS belongs, and information about a cooperative communication mode in which the first MS will perform cooperative communication, and transmitting to the one or more candidate MSs a message requesting a direct link connection to the first MS, the message including the identification information of the first MS and the information about the cooperative communication mode. A network linked between the first MS and the candidate cooperative MSs is heterogeneous from a network linked between the first MS and a BS.

In another aspect of the present invention, a first mobile station (MS) for performing cooperative communication in a wireless communication system includes a transmitter configured to transmit a first message requesting cooperative communication to a BS, the first message including at least one of identification information of at least one second MS linked to the first MS and information about a cooperative communication mode for performing cooperative communication with the at least one second MS, and a receiver configured to receive a second message from the BS, the second message including identification information of at least one third MS for performing cooperative communication from among the at least one second MS. A network linked between the first and second MSs is heterogeneous from a network linked between the first MS and the BS.

In another aspect of the present invention, a first mobile station (MS) for performing cooperative communication in a wireless communication system includes a transmitter for transmitting a first message requesting cooperative communication to a BS, the first message including at least one of identification information of the first MS, information about a cooperative communication for cooperative communication involving the first MS, and information enabling a direct link connection between the first MS and one or more candidate cooperative MSs capable of performing cooperative communication in a cell to which the first MS belongs.

The first MS includes a receiver for receiving a second message from the BS, the second message including identification information of at least one second MS that will perform cooperative communication from among the candidate cooperative MSs. A network linked between the first MS and the candidate cooperative MSs is heterogeneous from a network linked between the first MS and the BS.

In another aspect of the present invention, a base station (BS) for supporting cooperative communication between mobile stations (MSs) in a wireless communication system includes a receiver configured to receive a first message requesting cooperative communication from a first MS, the first message including at least one of identification information of at least one second MS linked to the first MS and information about a cooperative communication mode in which the first MS will perform cooperative communication with the at least one second MS, and a processor configured to perform grouping the first MS and a cooperative MS that will perform cooperative communication based on the at least one of the identification information of the at least one second MS and the information about the cooperative communication mode. A network linked between the first and second MSs is heterogeneous from a network linked between the first MS and the BS.

In a further aspect of the present invention, a base station (BS) for supporting cooperative communication between MSs in a wireless communication system includes a receiver configured to receive a first message requesting cooperative communication from a first MS, the first message including at least one of identification information of the first MS, information enabling a direct link connection between the first MS and one or more candidate cooperative MSs capable of performing cooperative communication in a cell to which the first MS belongs, and information about a cooperative communication mode in which the first MS will perform cooperative communication, and a transmitter configured to transmit to the one or more candidate MSs a message requesting a direct link connection to the first MS, the message including the identification information of the first MS and the information about the cooperative communication mode. A network linked between the first MS and the candidate cooperative MSs is heterogeneous from a network linked between the first MS and the BS.

### Advantageous Effects

In the method for performing or supporting cooperative communication between terminals according to the present invention, communication performance can be improved remarkably through throughput enhancement and power consumption reduction resulting from cooperative communication between terminals.

It will be appreciated by persons skilled in the art that the effects that can be achieved with the present invention are not limited to what has been particularly described hereinabove and other advantages of the present invention will be more clearly understood from the following detailed description taken in conjunction with the accompanying drawings.

### BRIEF DESCRIPTION OF THE DRAWINGS

The accompanying drawings, which are included to provide a further understanding of the invention and are incorporated in and constitute a part of this application, illustrate embodiments of the invention and together with the description serve to explain the principle of the invention. In the drawings:

FIG. 1 is a block diagram of an evolved Node B (eNB) 105 and a User Equipment (UE) 110 in a wireless communication system 100;

FIG. 2 illustrates an exemplary initial network entry operation of a UE;

FIG. 3 illustrates an exemplary operation for performing Client Cooperation (CC) between UEs;

FIG. 4 illustrates another exemplary operation for performing CC between UEs; and

FIG. 5 illustrates a further exemplary operation for performing CC between UEs.

### BEST MODE FOR CARRYING OUT THE INVENTION

Reference will now be made in detail to the preferred embodiments of the present invention with reference to the accompanying drawings. The detailed description, which will be given below with reference to the accompanying drawings, is intended to explain exemplary embodiments of the present invention, rather than to show the only embodiments that can be implemented according to the invention. The following detailed description includes specific details in order to provide a thorough understanding of the present invention. However, it will be apparent to those skilled in the art that the present invention may be practiced without such specific details. For example, while the following detailed description is given under the assumption that an Institute of Electrical and Electronics Engineers (IEEE) 802.16 system is being used as a mobile communication system, the description is applicable to other wireless communication systems except for specific features inherent to the IEEE 802.16 system.

In some instances, known structures and devices are omitted or are shown in block diagram form, focusing on important features of the structures and devices, so as not to obscure the concept of the invention. The same reference numbers will be used throughout this specification to refer to the same parts.

In the following description, a terminal generically refers to a mobile or fixed user terminal device such as a User Equipment (UE), a Mobile Station (MS), an Advanced Mobile Station (AMS), a Machine to Machine (M2M) terminal, an HTC terminal, a laptop, a tablet PC, etc. and a Base Station (BS) generically refers to any node at an end of a network, which communicates with a UE, such as a Node B, an evolved Node B (eNode B or eNB), or an Access Point (AP).

In a mobile communication system, a UE can receive information from an eNB on downlink and transmit data to the eNB on uplink. Information transmitted from or received at the UE includes data and various types of control information. There are many physical channels depending on the types and usages of information transmitted from or received at UEs.

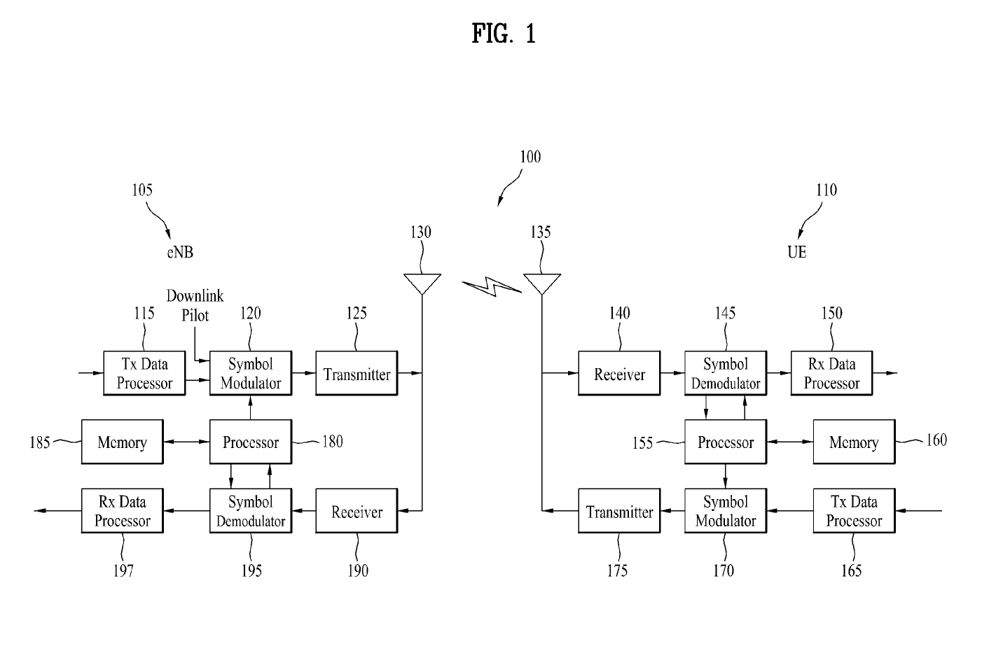

FIG. 1 is a block diagram of an eNB 105 and a UE 110 in a wireless communication system 100.

While one eNB 105 and one UE 110 are shown to simplify the configuration of the wireless communication system 100, the wireless communication system 100 may include one or more eNBs and/or one or more UEs in real implementation.

Referring to FIG. 1, the eNB 105 may include a Transmission (Tx) data processor 115, a symbol modulator 120, a transmitter 125, a Transmission/Reception (Tx/Rx) antenna 130, a processor 180, a memory 185, a receiver 190, a symbol demodulator 195, and an Rx data processor 197. The UE 110 may include a Tx data processor 165, a symbol modulator 170, a transmitter 175, a Tx/Rx antenna 135, a processor 155, a memory 160, a receiver 140, a symbol demodulator 145, and an Rx data processor 150. While each of the eNB 105 and the UE 110 is shown as having one Tx/Rx antenna 130 or 135, it has a plurality of Tx/Rx antennas. Accordingly, the eNB 105 and the UE 110 support Multiple Input Multiple Output (MIMO) according to the present invention. The eNB 105 may also support both Single User MIMO (SU-MIMO) and Multi-User MIMO (MU-MIMO) according to the present invention.

The Tx data processor 115 receives traffic data, formats the received traffic data, and subjects the formatted traffic data to encoding, interleaving, and modulation, thus producing modulation symbols (“data symbols”) on downlink. The symbol modulator 120 receives the data symbols and pilot symbols, processes the received data symbols and pilot symbols, and thus provides a stream of symbols.

After multiplexing the data symbols with the pilot symbols, the symbol modulator 120 transmits the multiplexed symbols to the transmitter 125. Each transmission symbol may be a data symbol, a pilot symbol, or a zero-valued signal. The pilot symbols may be transmitted contiguously during each symbol period. The pilot symbols may be multiplexed in Frequency Division Multiplexing (FDM), Orthogonal Frequency Division Multiplexing (OFDM), Time Division Multiplexing (TDM), or Code Division Multiplexing (CDM).

The transmitter 125 receives the symbol stream, converts the received symbol stream to one or more analog signals, and additionally adjusts the analog signals (e.g. amplification, filtering, and frequency upconversion), thus generating a downlink signal suitable for transmission on a radio channel. Then the Tx antenna 130 transmits the downlink signal to the UE.

In the configuration of the UE 110, the Rx antenna 135 provides the downlink signal received from the eNB to the receiver 140. The receiver 140 adjusts the received signal (e.g. by filtering, amplification, and frequency downconversion) and acquires samples by digitizing the adjusted signal. The symbol demodulator 145 demodulates the received pilot symbols and provides the demodulated pilot symbols to the processor 155, for use in channel estimation.

In addition, the symbol demodulator 145 receives a frequency response estimate for the downlink from the processor 155, acquires data symbol estimates (i.e. estimates of the transmitted data symbols) by demodulating the received data symbols, and provides the data symbol estimates to the Rx data processor 150. The Rx data processor 150 recovers the transmitted traffic data by subjecting the data symbol estimates to demodulation (i.e. symbol demapping), deinterleaving, and decoding.

The operations of the symbol demodulator 145 and the Rx data processor 150 are complementary to those of the symbol modulator 120 and the Tx data processor 115 in the eNB 105.

In the UE 110, the Tx data processor 165 produces data symbols on uplink by processing traffic data. The symbol modulator 170 multiplexes the data symbols received from the Tx data processor 165, modulates the multiplexed data symbols, and provides a stream of symbols to the transmitter 175. The transmitter 175 generates an uplink signal by receiving and processing the stream of symbols and the Tx antenna 135 transmits the uplink signal to the eNB 105.

In the eNB 105, the uplink signal is received from the UE 110 through the Rx antenna 130. The receiver 190 acquires samples by processing the received uplink signal. The symbol demodulator 195 provides estimates of pilot symbols and data symbols received on the uplink by processing the samples. The Rx data processor 197 recovers the traffic data transmitted by the UE 110 by processing the data symbol estimates.

The processor 155 of the UE 110 and the processor 180 of the eNB 105 instruct (e.g. control, adjust, and manage) operations in the UE 110 and the eNB 105, respectively. The processors 155 and 180 may be connected respectively to the memories 160 and 185 that store program codes and data. The memories 160 and 185 store Operating Systems (OSs), applications, and general files in connection to the processors 155 and 180.

The processors 155 and 180 may be called controllers, microcontrollers, microprocessors, microcomputers, etc. Meanwhile, the processors 155 and 180 may be implemented in hardware, firmware, software, or a combination thereof. In a hardware configuration, the processors 155 and 180 may be provided with Application Specific Integrated Circuits (ASICs), Digital Signal Processors (DSPs), Digital Signal Processing Devices (DSDPs), Programmable Logic Devices (PLDs), Field Programmable Gate Arrays (FPGAs), etc. which are configured to implement the present invention.

In a firmware or software configuration, embodiments of the present invention may be implemented in the form of a module, a procedure, a function, etc. Firmware or software configured to implement the present invention may reside in the processors 155 and 180 or may be stored in the memories 160 and 185 and executed by the processors 155 and 180.

The layers of radio interface protocols between a UE and an eNB may be classified into Layers 1, 2 and 3 (L1, L2 and L3) based on the three lowest layers of the Open System Interconnection (OSI) model. A physical layer corresponds to L1 and provides information transfer service on physical channels. A Radio Resource Control (RRC) layer corresponds to L3 and provides radio control resources between the UE and the network. The UE/eNB may exchange RRC messages with the wireless communication network through the RRC layer.

The present invention provides a UE grouping method to support Client Cooperation (CC) in a wireless communication system. It is assumed in the present invention that a direct link between UEs performing CC is a network (e.g. WiFi) different from a cellular network between a UE and an eNB. In this situation, a UE grouping method for supporting CC between UEs is provided. While a direct link between UEs is described in the context of WiFi herein, it does not limit the present invention.

Data is transmitted between an eNB and a UE or between a relay and a UE only via a radio link in a legacy wireless communication system. However, client cooperation between UEs has recently been proposed to enhance throughput, reduce UE power consumption, and extend cell coverage.

In the specification, UEs being client cooperation entities will be referred to as a source UE or node and a cooperative UE or node. However, the present invention is not limited to these specific names. The source UE is a UE being a transmission and reception entity in data transmission and reception to and from an eNB and/or a relay and the cooperative UE is a UE that helps data transmission and reception between the source UE and the eNB and/or the relay.

In general, client cooperation between UEs may involve grouping of a source UE and a cooperative UE, data sharing through direct communication between the source UE and the cooperative UE, and data transmission and reception between an eNB and the source and cooperative UEs. The client cooperation procedure may be changed according to a client cooperation mode (or scenario). One or more source UEs and one or more cooperative UEs may be configured and the roles of the source and cooperative UEs may be dynamically changed in a group of UEs, which will be described later.

First of all, a UE grouping method for client cooperation between UEs will be described. Particularly, a description will be given of a UE grouping method in the case where direct link communication is conducted for client cooperation between UEs in Wireless Fidelity (WiFi) mode or WiFi ad-hoc mode. For this purpose, identification information of each UE in a network (e.g. address information in a WiFi network) is shared with an eNB in a cellular network, thus enabling efficient and simple UE grouping. While the present invention is described in the context of an IEEE 802.16-series wireless communication system, the same description is applicable to other wireless mobile communication systems of the same type (e.g. 3^{rd} Generation Long Term Evolution (3GPP LTE) systems).

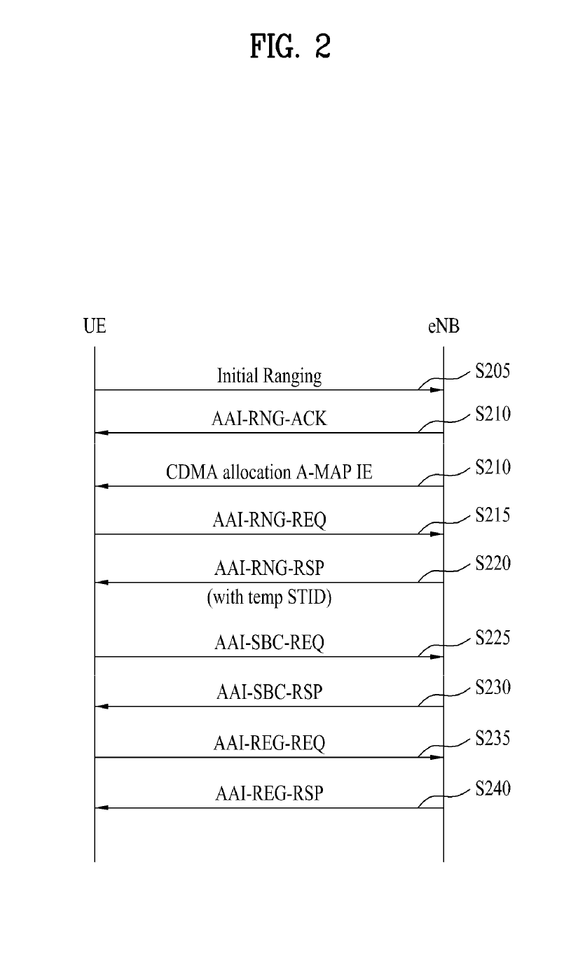

Before performing client cooperation between UEs, a UE needs to enter a network and register to the network. With reference to FIG. 2, a network entry operation of a UE will be described in brief.

FIG. 2 illustrates an exemplary initial network entry procedure of a UE.

Referring to FIG. 2, the UE performs initial ranging with an eNB (S205). The initial ranging is the process of acquiring an accurate timing offset with the eNB and adjusting initial transmission power. In general, when an HTC device is powered on, the UE acquires downlink synchronization using a downlink preamble signal received from the eNB. Subsequently, the UE performs initial ranging to adjust an uplink timing offset and transmission power. After selecting a ranging channel, the UE selects a ranging preamble code from an initial ranging domain and transmits the selected ranging preamble on the selected ranging channel to the eNB (S205).

Then the eNB may transmit an ACKnowledgement (ACK) message (e.g. an AAI-RNG-ACK message) for the initial ranging of the UE (S210). The AAI-RNG-ACK message provides a response indicating that ranging preamble codes have been successfully received and detected in all ranging opportunities. The eNB may indicate one of three available ranging statuses for the initial ranging in the AAI-RNG-ACK message. The three available ranging statuses are “continue”, “success”, and “abort”.

To provide information needed for transmission of an AAI-RNG-REQ message, the eNB may transmit a CDMA Allocation A-MAP IE message to the UE, instead of the AAI-RNG-ACK message in step S210.

The UE may then transmit a message requesting ranging (e.g. an AAI-RNG-REQ message) in allocated resources to the eNB (S215). The eNB transmits a message confirming reception of the AAI-RNG-REQ message (e.g. an AAI-RNG-RSP message) to the UE (S220). In case of a Hybrid Automatic Repeat reQuest (HARQ) system, the UE may transmit a message requesting negotiation of basic capabilities (e.g. an AAI-SBC-REQ message) to the eNB (S225). The eNB may transmit to the UE a message confirming reception of the AAI-SBC-REQ message (e.g. an AAI-SBC-RSP message) in response to the AAI-SBC-REQ message (S230).

The UE may transmit a message for capability negotiation and network registration (e.g. an AAI-REG-REQ message) to the eNB during network entry (S235). The eNB may transmit to the UE a message confirming reception of the AAI-REG-REQ message (e.g. an AAI-REG-RSP message) in response to the AAI-REG-REQ message (S240). The UE completes the entry into the network to which the eNB belongs by these operations.

Every UE capable of performing client cooperation (every client cooperation-enabled UE) may transmit to an eNB an information area indicating supportability of WiFi mode or WiFi ad-hoc mode (e.g. a bitmap scheme may be used using 1 bit) and an information area including the Identifier (ID) of the client cooperation-enabled UE (e.g. the Medium Access Control (MAC) or Internet Protocol (IP) address of the client cooperation-enabled UE) in a WiFi network, when UE capabilities are negotiated during initial network entry, handover, or network reentry involving transition from idle mode to active mode. For this purpose, each of the UEs may transmit the information indicating supportability of WiFi mode or WiFi ad-hoc mode in the form of a conventional AAI-RNG-REQ, AAI-SBC-REQ, or AAI-REG-REQ message to the eNB. Alternatively, the UE may transmit the information in a newly defined MAC management message to the eNB. This new MAC management message will be referred to as an ‘AAI-CC-CNF’ message, which should not be construed as limiting the present invention. Thus the new MAC management message may be named differently.

As described above, the eNB may create a table by mapping the WiFi MAC or IP address of each client cooperation-enabled UE to the Station ID (STID) of the client cooperation-enabled UE in a one-to-one correspondence. That is, the eNB may identify each UE by mapping an STID allocated to the UE to a WiFi MAC or IP address received from the UE during initial network entry of the UE. The eNB may use the table in UE grouping for client cooperation. Meanwhile, the table in which the WiFi MAC or IP addresses of UEs are one-to-one mapped to the STIDs of the UEs may be preset. The STIDs of UEs are IDs that the eNB allocate to the individual UEs during initial network entry. If the WiFi MAC or IP address of a UE is changed later, the UE may signal the changed WiFi MAC or IP address to the eNB to thereby share the changed information with the eNB.

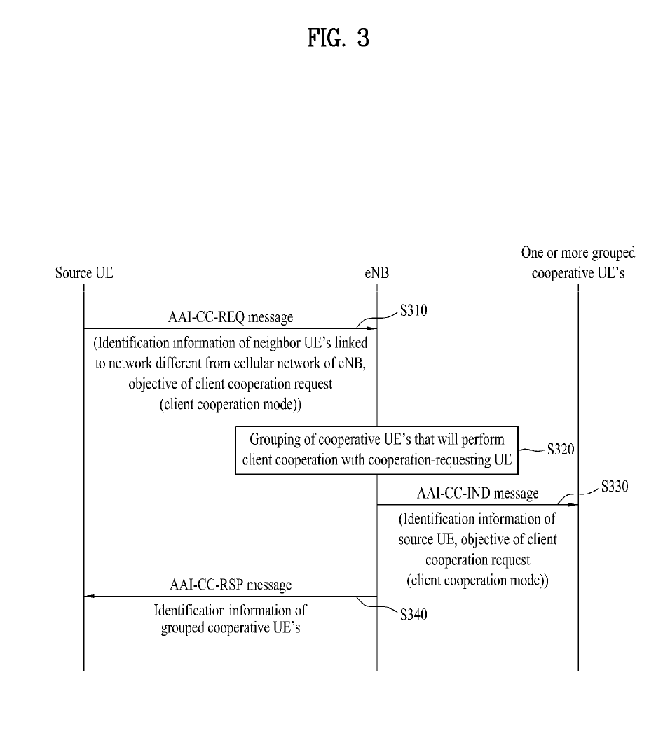

FIG. 3 is a diagram illustrating a signal flow for an exemplary operation for performing client cooperation between UEs.

Referring to FIG. 3, when a source UE determines that client cooperation is needed, the source UE may request client cooperation to an eNB (S310). The client cooperation request may be transmitted in a MAC management message. While the MAC management message requesting client cooperation will be referred to as an ‘AAI-CC-REQ’ message, the present invention is not limited to the specific message name. Before the source UE transmits the AAI-CC-REQ message, the source UE may acquire the WiFi MAC or IP addresses of UEs connected to WiFi ad-hoc links by searching for WiFi-mode or WiFi ad-hoc-mode neighbor UEs. The source UE may transmit the acquired the WiFi MAC or IP addresses of the UEs connected to the WiFi ad-hoc links in the AAI-CC-REQ message to the eNB (S310). The source UE may also transmit information about the channel states of the WiFi ad-hoc links of the detected UEs in the AAI-CC-REQ message to the eNB (S310). Further, the source UE may transmit information about the objective of the client cooperation request in the AAI-CC-REQ message to the eNB (S310). That is, the source UE indicates its objective for client cooperation to the eNB by indicating an intended client cooperation mode among various client cooperation modes. That is, the source UE may notify the eNB whether the objective of the client cooperation request is to minimize the power consumption of the source UE or to enhance the throughput of the source UE. In addition, the source UE may notify the eNB of its preference between simultaneous transmission from the source UE and a cooperative UE and transmission from the cooperative UE only, as the objective of the client cooperation request. Or information that distinguishes uplink from downlink or a UE's request indicating whether to additionally receive help from the cooperative UE through cooperation regarding downlink system information in spite of uplink cooperation may be transmitted.

The processor 180 of the eNB may group the source UE and a cooperative UE that will perform client cooperation based on the received message (S320). Especially, the processor 180 of the eNB may group the UEs, taking into account the client cooperation objective (or client cooperation mode) requested by the source UE, the state of a link between the source UE and a cooperative UE, and the state of a link between the eNB and the cooperative UE (S320). For example, if the client cooperation mode requested by the source UE is power consumption mode, the eNB may group the source UE with a neighbor UE near to the source UE by more heavily weighting the distance between the cooperative UE and the source UE than the channel state between the eNB and the cooperative UE. In another example, if the source UE-requested client cooperation mode is throughput enhancement mode, the processor 180 of the eNB may take into account the channel state between the eNB and a cooperative UE and thus may select a UE near to the source UE as a cooperative UE, from among UEs in good channel states. In this manner, the factor used for the processor 180 of the eNB to determine a cooperative UE may vary according to the source UE-requested client cooperation mode. That is, the processor 180 of the eNB may consider the distance between a cooperative UE and the source UE or the channel state between the cooperative UE and the eNB in grouping the source UE with the cooperative UE.

Subsequently, the eNB may transmit the ID (e.g. WiFi MAC or IP address) of the grouped cooperative UE to the source UE in an AAI-CC-RSP message (S340). Or the eNB may transmit only an ACK signal in response to the client cooperation request of the source UE (S340). Accordingly, the source UE may acquire information about one or more grouped cooperative UEs that will perform client cooperation with it.

Meanwhile, before transmitting the ID of the cooperative UE or the ACK signal in response to the client cooperation request (S340), the eNB may transmit a message indicating that client cooperation will be performed for the source UE to the at least one grouped cooperative UE (S330). The message indicating client cooperation may be referred to as an AAI-CC-IND message, which does not limit the present invention. The eNB may indicate implementation of client cooperation for the source UE to the cooperative UE by transmitting the ID (e.g. WiFi MAC or IP address) of the source UE in the AAI-CC-IND message (S330). The eNB may further include information about the source UE-requested client cooperation mode in the AAI-CC-IND message (S330). That is, the information about the source UE-requested client cooperation mode may include various information such as whether the source UE requests a mode of relaying uplink data to a nearby cooperative UE for the purpose of power reduction so that the cooperative UE transmits the uplink data to the eNB or the source UE requests a client cooperation mode for throughput enhancement. Obviously, the eNB may transmit the information about the client cooperation mode to the source UE, when needed.

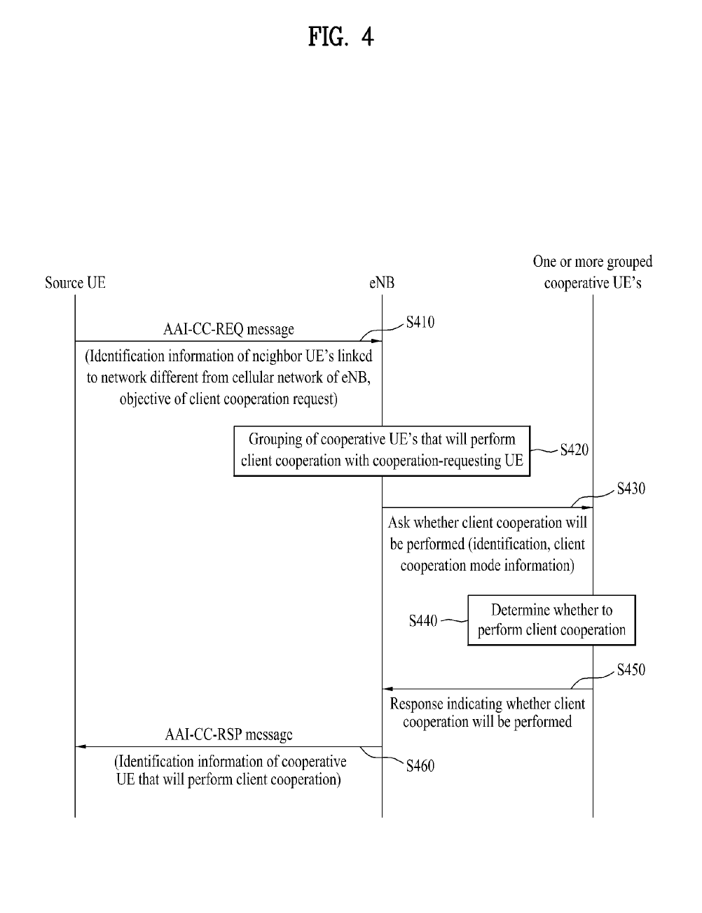

FIG. 4 is a diagram illustrating a signal flow for another exemplary operation for performing client cooperation between UEs.

As described before with reference to FIG. 3, when a source UE determines that client cooperation is needed, the source UE may request client cooperation to an eNB (S410). While the client cooperation request may be transmitted in an AAI-CC-REQ message, the present invention is not limited to this specific message. The source UE may include the WiFi MAC or IP addresses of UEs connected to WiFi ad-hoc links, information about the objective of the client cooperation request, etc. in the AAI-CC-REQ message (S410). The source UE may also transmit information about the channel states of the WiFi ad-hoc links of the UEs in the AAI-CC-REQ message to the eNB (S410).

The processor 180 of the eNB may group the source UE and a cooperative UE that will perform client cooperation, taking into account the objective of client cooperation (or a client cooperation mode) requested by the source UE, the link state between the source UE and the cooperative UE, and the link state between the eNB and the cooperative UE (S420).

Unlike the client cooperation operation illustrated in FIG. 3, before instructing at least one UE grouped with the source UE to perform client cooperation by transmitting an AAI-CC-IND message to the UE, the eNB may transmit a message asking whether the cooperative UE will perform client cooperation with the source UE (S430). Herein, the eNB may transmit the ID (e.g. WiFi MAC or IP address, including the client cooperation mode) of the source UE to the cooperative UE (S430).

Then the processor of the at least one cooperative UE may determine whether to perform client cooperation for the source UE (S440) and may transmit the determination result in the form of a response message to the eNB (S450). The eNB may transmit the ID of a cooperative UE that will perform client cooperation (or accept the client cooperation request) in an AAI-CC-RSP message to the source UE (S460).

The operations of FIGS. 3 and 4 may be performed upon request of a source UE or may be initiated for a UE by the eNB. In the latter case, the eNB needs to transmit a message indicating client cooperation to a source UE requiring client cooperation.

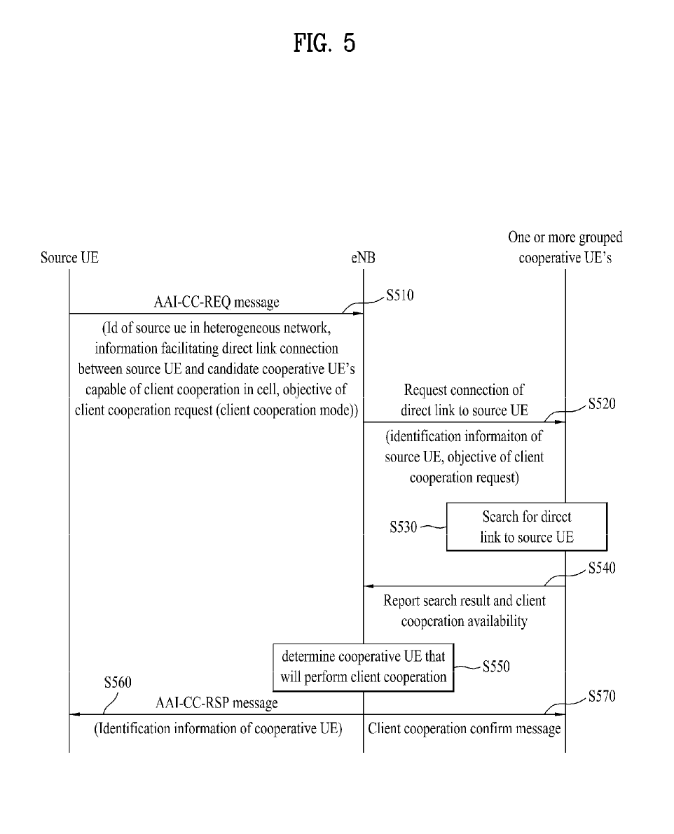

FIG. 5 is a diagram illustrating a signal flow for a further exemplary operation for performing client cooperation between UEs.

In order to perform the client cooperation operation between UEs described before with reference to FIGS. 3 and 4, a source UE and cooperative UEs should always activate a WiFi modem, a Tx/Rx antenna, an RF chain, etc. to discover neighbor UEs in a network connected between UEs (e.g. a WiFi network). As a result, the UEs may suffer from unnecessary power consumption. To prevent the unnecessary power consumption, the UEs may conduct WiFi ad-hoc communication only when client cooperation or direct communication between UEs is needed. For example, as illustrated in FIG. 5, when a specific source UE determines that client cooperation is needed, it may transmit an AAI-CC-REQ message to an eNB (S510). The source UE may transmit, in the AAI-CC-REQ message, its own ID (its WiFi MAC or IP address), information (timing information) that facilitates a direct link connection between the source UE and client cooperation-enabled candidate cooperative UEs by WiFi neighbor UE discovery, and the objective of the source UE's client cooperation request (i.e. a client cooperation mode) (S510).

Upon receipt of the AAI-CC-REQ message, the eNB may transmit to one or more candidate cooperative UEs a message requesting setup of a WiFi direct link connection with the source UE (S520). That is, the eNB may transmit to the candidate cooperative UEs a message requesting search for the source UE by the WiFi neighbor UE discovery (S520). Herein, the eNB may also transmit the ID (e.g. WiFi MAC or IP address) of the source UE and information about a WiFi direct link objective or a WiFi direct link mode requested by the source UE to the one or more candidate cooperative UEs (S520).

Then each candidate cooperative UE may search for a WiFi direct link to the source UE requesting a WiFi direct link (S530) and may report the search result and client cooperation availability to the eNB (S540).

The processor 180 of the eNB may select (or determine) a cooperative UE to perform client cooperation based on the search result regarding the WiFi direct link and the information indicating whether client cooperation is available, received from each candidate cooperative UE (S550). Then the eNB may transmit the ID (or WiFi MAC or IP address) of the selected (or determined) cooperative UE to the source UE by an AAI-CC-RSP message (S560). In addition, the eNB may transmit to the selected cooperative UE a confirm message indicating client cooperation implementation (S570).

The afore-described candidate cooperative UEs may all UEs that can perform client cooperation within a cell. The eNB may configure a cell-specific client cooperation STID to facilitate message transmission to the candidate cooperative UEs. That is, the eNB may configure a cell-specific client cooperation STID only for client cooperation-enabled UEs and notify the client cooperation-enabled UEs of the cell-specific client cooperation STID during capability negotiation, when the UEs perform network entry/reentry.

When a specific source UE requests client cooperation or the eNB requests client cooperation for a specific UE, the eNB may transmit information for multicasting a message to cooperative UEs capable of performing client cooperation for the source UE using the cell-specific client cooperation STID. The eNB may transmit a control channel (e.g. an A-MAP-IE) having a CRC masked by the cell-specific CC STID. The eNB may transmit client cooperation information directly in the A-MAP-IE. Or the eNB may transmit resource allocation information about a data channel carrying client cooperation information simultaneously to UEs capable of performing client cooperation in the cell.

The eNB may a group-specific client cooperation STID by grouping client cooperation-enabled UEs according to a specific condition in order to narrow the range of candidate cooperative UEs. That is, the eNB configures a group-specific client cooperation STID only for specific UEs from among client cooperation-enabled UEs and notify the UEs of the group of the group-specific client cooperation STID during capability negotiation, when the UEs perform network entry/reentry.

Even after the network entry/reentry of the UEs, the eNB may reconfigure the group-specific CC STID for the specific UEs. For example, if the specific grouping condition is UE position, the eNB may allocate the group-specific client cooperation STID according to the positions of UEs in the cell. Since the location of a UE can be dynamically changed due to its mobility, the eNB needs to change the group-specific CC STID according to the location of the UE.

When the group-specific client cooperation STID needs to be updated due to movement of a UE, the eNB may reconfigure the group-specific client cooperation STID by a MAC management message or may transmit an updated group-specific client cooperation STID to the UEs of the group on a control channel like an A-MAP-IE. In this case, the eNB may allocate the group-specific CC STID only to UEs for which Location Base Service (LBS) is supported in order to track down the UEs.

Or the eNB may group UEs belonging to the same user or the same user group and allocate a group-specific client cooperation STID to the grouped UEs. That is, the eNB may allocate a group-specific client cooperation STID to UEs of the same user group (e.g. a mobile terminal, a laptop, a tablet PC, etc. of a specific user). When a specific source UE requests client cooperation in the group or the eNB requests client cooperation for a specific UE, the eNB may transmit information for multicasting a message to cooperative UEs capable of performing client cooperation for the source UE using the group-specific CC STID. That is, the eNB may directly transmit client cooperation information on a control channel having a CRC masked by the corresponding group-specific CC STID (e.g. an A-MAP-IE) or may simultaneously transmit resource allocation information about a data channel carrying client cooperation information to the grouped UEs.

As described before, UEs supporting the WiFi ad-hoc mode may transmit their identification information (i.e. their WiFi MAC or IP addresses) to the eNB. Herein, each UE may transmit the WiFi MAC addresses of UEs with which the UE has established WiFi ad-hoc links as well as its WiFi MAC address to the eNB. The UEs connected to the corresponding WiFi ad-hoc links may belong to the same user. In this case, the UEs may also transmit measurements of channels established with the UEs connected via the WiFi ad-hoc links. For example, if a plurality of UEs of the same user are connected to an eNB and direct communication can be conducted between these UEs in the WiFi ad-hoc mode, the plurality of UEs may transmit to the eNB the WiFi MAC or IP addresses of UEs with which they can communicate directly in the WiFi ad-hoc mode as well as their WiFi MAC or IP addresses. In addition, the plurality of UEs may transmit channel state information about the WiFi direct links of the individual UEs to the eNB.

All of the UEs may transmit the WiFi MAC or IP addresses of the UEs with which the UEs can directly communicate in the WiFi ad-hoc mode. Or if the UEs belong to the same user, a specific header (or representative) UE may transmit to the eNB the WiFi MAC or IP addresses of UEs with which the UE can directly communicate in the WiFi ad-hoc mode. The eNB may group UEs among which WiFi ad-hoc connections can be established based on the WiFi MAC addresses of the UEs that can conduct direct communication in the WiFi ad-hoc mode. The eNB may also allocate a group-specific client cooperation STID to the grouped UEs and transmit the group-specific client cooperation STID to them. Notably, if a specific source UE requests client cooperation to the eNB, the source UE may designate a cooperative UE on its own.

UEs may be paired for client cooperation within the group or between groups. The eNB may configure a new pairing STID only for the paired UEs for client cooperation and allocate the new pairing STID to the paired UEs. The pairing ID is a temporary STID shared between the paired UEs for performing client cooperation, different from the afore-described cell-specific or group-specific client cooperation STID.

A plurality of UEs may be paired for client cooperation. During client cooperation between the paired CCs, the source UE and the cooperative UE are not static. In fact, the source UE and the cooperative UE may be changed dynamically depending on a UE between the paired UEs that transmits data to and receives data from the eNB. For example, let's assume that UE A and UE B are paired for client cooperation. If data is transmitted and received between UE A and an eNB, UE A and UE B operate as a source UE and a cooperative UE, respectively. In the opposite case where data is transmitted and received between UE B and the eNB, UE A and UE B operate as a cooperative UE and a source UE, respectively. For UEs performing dynamic client cooperation, the eNB may transmit an information area indicating the operation mode of a corresponding UE (i.e. whether the corresponding UE is a source UE or a cooperative UE) on a control channel (e.g. an Assignment AMAP-IE) configured for the paired UEs.

An IEEE 802.16m system, which is an example of a wireless communication system, supports multiple connections for a single UE. Accordingly, the UE needs to distinguish the connections from one another. A flow ID is an ID identifying a connection in the UE. The eNB may configure a specific flow ID used in an Advanced Air Interface (AAI) as a client cooperation flow ID. The eNB may transmit the client cooperation flow ID to UEs in system information or only to client cooperation-enabled UEs during their network entry. In this case, a source UE and a cooperative UE that perform client cooperation may decode a client cooperation connection using the CC flow ID.

The embodiments of the present invention described above are combinations of elements and features of the present invention. The elements or features may be considered selective unless otherwise mentioned. Each element or feature may be practiced without being combined with other elements or features. Further, an embodiment of the present invention may be constructed by combining parts of the elements and/or features. Operation orders described in embodiments of the present invention may be rearranged. Some constructions of any one embodiment may be included in another embodiment and may be replaced with corresponding constructions of another embodiment. It is obvious to those skilled in the art that claims that are not explicitly cited in each other in the appended claims may be presented in combination as an embodiment of the present invention or included as a new claim by a subsequent amendment after the application is filed.

Those skilled in the art will appreciate that the present invention may be carried out in other specific ways than those set forth herein without departing from the spirit and essential characteristics of the present invention. The above embodiments are therefore to be construed in all aspects as illustrative and not restrictive. The scope of the invention should be determined by the appended claims and their legal equivalents, not by the above description, and all changes coming within the meaning and equivalency range of the appended claims are intended to be embraced therein.

### INDUSTRIAL APPLICABILITY

The apparatus and method for performing client cooperation between UEs and the apparatus and method for supporting client cooperation between UEs are industrially applicable to various communication systems including IEEE 802.16, 3GPP LTE, and LTE-A systems.

1-3. (canceled)

4. A method for performing cooperative communication between mobile stations (MSs) in a wireless communication system, the method comprising:
transmitting, by a first MS, a first message requesting cooperative communication to a Base Station (BS), the first message including at least one of identification information of the first MS, information about a cooperative communication mode for cooperative communication involving the first MS, and information enabling a direct link connection between the first MS and one or more candidate cooperative MSs capable of cooperative communication in a cell to which the first MS belongs; and
receiving, by the first MS, a second message from the BS, the second message including identification information of at least one second MS that will perform cooperative communication from among the candidate cooperative MSs,
wherein a network linked between the first MS and the candidate cooperative MSs is heterogeneous from a network linked between the first MS and the BS.

5. A method for supporting cooperative communication between mobile stations (MSs) in a wireless communication system, the method comprising:
receiving, from a first MS, a first message requesting cooperative communication, the first message including at least one of identification information of at least one second MS linked to the first MS and information about a cooperative communication mode for cooperative communication between the first MS and the at least one second MS; and
grouping the first MS and a cooperative MS that will perform cooperative communication with the first MS based on the at least one of the identification information of the at least one second MS linked to the first MS and the information about the cooperative communication mode,
wherein a network linked between the first and second MSs is heterogeneous from a network linked between the first MS and a Base Station (BS).

6. The method according to claim 5, further comprising transmitting identification information of the grouped cooperative MS to the first MS.

7. The method according to claim 5, further comprising transmitting to the grouped cooperative MS a message asking whether the grouped cooperative MS will perform cooperative communication, the message including at least one of identification information of the first MS and the information about the cooperative communication mode.

8. The method according to claim 7, further comprising receiving a response message indicating whether the requested cooperative communication will be performed from the grouped cooperative MS.

9. The method according to claim 8, further comprising transmitting to the first MS identification information of a cooperative MS that has transmitted an acknowledgment for the cooperative communication request.

10. A method for supporting cooperative communication between mobile stations (MSs) in a wireless communication system, the method comprising:
receiving, from a first MS, a first message requesting cooperative communication, the first message including at least one of identification information of at least one second MS linked to the first MS and information about a cooperative communication mode for cooperative communication between the first MS and the at least one second MS; and
grouping the first MS and a cooperative MS that will perform cooperative communication with the first MS based on the at least one of the identification information of the at least one second MS linked to the first MS and the information about the cooperative communication mode,
wherein a network linked between the first and second MSs is heterogeneous from a network linked between the first MS and a Base Station (BS).

11. A method for supporting cooperative communication between mobile stations (MSs) in a wireless communication system, the method comprising:
receiving, from a first MS, a first message requesting cooperative communication, the first message including at least one of identification information of the first MS, information enabling a direct link connection between the first MS and one or more candidate cooperative MSs capable of performing cooperative communication in a cell to which the first MS belongs, and information about a cooperative communication mode in which the first MS will perform cooperative communication; and
transmitting to the one or more candidate MSs a message requesting a direct link connection to the first MS, the message including the identification information of the first MS and the information about the cooperative communication mode,
wherein a network linked between the first MS and the candidate cooperative MSs is heterogeneous from a network linked between the first MS and a Base Station (BS).

12. The method according to claim 11, further receiving from the one or more candidate MSs information indicating whether the requested cooperative communication can be performed.

13. The method according to claim 12, further comprising determining at least one cooperative MS to perform cooperative communication with the first MS based on the information indicating whether the requested cooperative communication can be performed.

14. The method according to claim 13, further comprising transmitting identification information of the determined at least one cooperative MS to the first MS.

15. The method according to claim 13, further comprising transmitting a message confirming the cooperative communication to the determined at least one cooperative MS.

16-20. (canceled)
